(19) United States
(12) Patent Application Publication
(10) Pub. No.: US 2015/0332380 A1
(43) Pub. Date: Nov. 19, 2015

(54) SYSTEM AND METHOD FOR BUNDLING, SELLING, AND DELIVERING TANGIBLE ITEMS AND ASSOCIATED VIDEOS IN AN EVENT DRIVEN E-COMMERCE SYSTEM

(71) Applicant: itsbyu, LLC, New York, NY (US)

(72) Inventors: CHRISTINE STRZALKA, New York, NY (US); CAROLINE STRZALKA, New York, NY (US)

(21) Appl. No.: 14/714,724

(22) Filed: May 18, 2015

Related U.S. Application Data
(60) Provisional application No. 61/994,565, filed on May 16, 2014.

(51) Int. Cl. G06Q 30/06; G09B 19/00; G06Q 10/08; G09B 5/06

(52) U.S. Cl. CPC G06Q 30/0635; G09B 5/065; G09B 19/00; G06Q 10/0832

(57) ABSTRACT

An e-commerce system, method, and non-transitory computer readable storage medium with a computer processor to execute the method is provided for bundling, selling, and delivering do-it-yourself project kits, which include tangible perishable items and associated instructional videos to consumers. The method includes receiving an order for at least one product kit and specifying a recipient and an event date, wherein the kit includes one or more items and an instructional video associate with the item. The order is fulfilled by shipping the item to the recipient a predetermined amount of time before the event date, and transmitting prior to the event date, by operation of the computer processor, a link to the instructional video for viewing by the recipient for a predetermined amount of time after the event date.

### CROSS-REFERENCES TO RELATED APPLICATIONS

This application claims the benefit of provisional patent application Ser. No. 61/994,565 filed in the United States Patent and Trademark Office on May 16, 2014, the entire disclosure of which is incorporated by reference herein.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE EFS-WEB

Not applicable.

### STATEMENT REGARDING PRIOR DISCLOSURES BY THE INVENTOR OR A JOINT INVENTOR

Not applicable.

### SEQUENCE LISTING

Not applicable.

### BACKGROUND OF THE INVENTION

1. Field of the Invention

This invention relates to electronic commerce (e-commerce) systems, and more particularly, to an event driven e-commerce system and method for bundling, selling, and delivering do-it-yourself project kits, which include tangible perishable items and associated instructional videos to consumers.

2. Description of the Related Art

Over 200 million Americans will engage in e-commerce (i.e. online shopping) activity this year to buy goods and services from merchants over the Internet using a web browser. Consumers, merchants and vendors are constantly seeking new ways to attract customers online, while increasing profits and revenue. With the free flow of information online, consumers have become more engaged in using the Internet to complete do-it-yourself (DIY) projects. Consumers now have the ability to browse online for instructional videos, using websites like YouTube®, and complete projects themselves in the privacy of their own homes. However, the consumer must purchase all the materials and items necessary to complete the project before engaging in such project. This can be an arduous, time-consuming, and even impossible task if the materials are not available locally or online.

For example, customers interested in completing a DIY flower arrangement must first source and purchase the flowers and associated materials required and then browse online for instructions on how to complete the arrangement. Not only are flowers perishable, but small arrangements may require several different types of flowers, some of which may not be readily available locally or in such small quantities. In addition, the materials and flowers may need to be purchased from different vendors. Purchasing small quantities of particular flowers and materials from multiple vendors, guaranteeing the flowers arrive healthy and fresh for arranging, and coordinating delivery so that the flowers arrive on time before a deadline, is not a simple task. Once the flowers arrive, the consumer must still find an online video that teaches them how to use the materials and complete the arrangement.

It is, therefore, a primary object of the present invention to provide an e-commerce system which gives consumers the ability, through a single online purchase, to make a finished product (i.e. a flower arrangement).

It is another object of the present invention to provide a system and method for bundling together items and an associated instructional video for completing the DIY project.

It is another object of the present invention to provide an event driven e-commerce system, which allows consumers to make the finished product with perishable items, in advance of an event driven deadline. For example, allowing the consumer to make DIY bridal bouquets in advance of a wedding.

It is another object of the present invention to provide a system and method for coordinating delivery of the tangible and perishable items in advance of the event driven date.

It is another object of the present invention to provide a system and method for coordinating shipment of tangible items and materials with the electronic delivery of the associated instructional video.

It is another object of the present invention to provide a system and method for controlling access and permission for viewing the instructional video in accordance with the event driven deadline.

It is another object of the present invention to provide a DIY project kit which may involve a variety of projects, including but not limited to, flowers, faux flowers, perfume, cuisine, furniture, home décor, event décor, gardening, fashion, jewelry, accessories, toys, make-up, food, crafts, clothing and/or automotive.

### BRIEF SUMMARY OF THE INVENTION

In accordance with one aspect of the present invention, a method of providing one or more project kits to a customer prior to an event date utilizing a computer-implemented e-commerce system is disclosed. The method comprising the steps of receiving an order for at least one product kit and specifying a recipient and an event date. The order has been made by a customer and the kit includes at least one item and an instructional video associate with the item. The method includes fulfilling the order further by shipping the item to the recipient a predetermined amount of time before the event date, and transmitting prior to the event date, by operation of one or more computer processors, at least an indication of the instructional video for viewing by the recipient for a predetermined amount of time after the event date.

The method further includes providing an interface through which the recipient can view the instructional video on a computing device associated with the recipient.

The method further includes the step of storing the plurality of instructional videos in a non-transitory computer readable storage medium.

The method further includes the step of associating each video in the storage medium with one more project kits.

The method includes the step of processing online orders for the kit, by operation of one or more computer processors operably connected with the storage medium.

The method further includes the step of fulfilling the order including providing, by operation of one or more computer processors, confirmation details that the item has shipped to the recipient, and transmitting simultaneously with the confirmation details, the indication of the instructional video for viewing by the recipient.

The method may include sending the instructional video electronically to the recipient through the Internet.

The method may include transmitting the indication of the instructional video as a URL to the recipient through an electronic message.

The method may include the item being perishable goods. The method may include the item being shipped four days prior to the event date.

The method may further include the step of expiring customer access to the instructional video after a predetermined amount of time has passed from the event date.

The method may include viewing the instructional video for a predetermined amount of time after the event date, where the predetermined time is twenty-four hours.

In accordance with an additional embodiment, a system of providing one or more project kits to a customer prior to an event date utilizing a computer-implemented e-commerce system is disclosed. The system includes means for storing a plurality of instructional videos associated with one or more items bundled together for sale as a kit, means for processing online orders for the kits received from a customer, where the means are operably connected with the storing means. The system further includes means for fulfilling the order comprising, means for shipping the item to the recipient a predetermined amount of time before the event date, and means for transmitting prior to the event date, by operation of the processor, at least an indication of the instructional video for viewing by the recipient for a predetermined amount of time after the event date.

The system further includes means for providing an interface through which the recipient can view the instructional video on a computing device associated with the recipient.

The means for storing the plurality of instructional videos includes a non-transitory computer readable storage medium.

The system further includes means for associating each video with one more project kits.

The system further includes means for processing online orders for the kit, by operation of one or more computer processors operably connected with the storage medium.

The means for fulfilling the order further includes means for providing confirmation details that the item has shipped to the recipient, and means for transmitting simultaneously with the confirmation details, the indication of the instructional video for viewing by the recipient.

The system further includes means for sending the instructional video to the recipient through the Internet.

The system wherein the indication of the instructional video may be a URL transmitted to the recipient through an electronic message.

The system may include the item being perishable goods. The system may include the item being shipped four days prior to the event date.

The system may further include means for expiring customer access to the instructional video after a predetermined amount of time has passed from the event date.

The predetermined amount of time for viewing the instructional video after the event date may be twenty-four hours.

In accordance with an additional embodiment a non-transitory computer-readable storage medium containing a computer program that, when executed, causes an event driven e-commerce system to perform steps is disclosed. The steps include receiving an order for at least one kit and specifying a recipient and an event date, wherein the order having been made by a customer, and wherein the kit includes an item and an instructional video associate with the item. The steps include sending the item to the recipient a predetermined amount of time before the event date, and transmitting prior to the event date at least an indication of the instructional video for viewing by the recipient for a predetermined amount of time after the event date.

The non-transitory computer-readable storage medium further includes providing an interface through which the recipient can view the instructional video on a computing device associated with the recipient.

The non-transitory computer-readable storage medium further includes storing the instructional video in a database, and associating the instructional video with at least one kit.

The non-transitory computer-readable storage medium further including processing online orders for the kit, by operation of one or more computer processors operably connected with the storage medium.

The non-transitory computer-readable storage medium wherein to fulfill the order further includes providing confirmation details that the item has shipped to the recipient, and transmitting simultaneously with the confirmation details, the indication of the instructional video for viewing by the recipient.

The non-transitory computer-readable storage medium further includes sending the instructional video to the recipient through the Internet.

The non-transitory computer-readable storage medium wherein indication of the instructional video may be a URL transmitted to the recipient through an electronic message.

The non-transitory computer-readable storage medium wherein the item is perishable goods. The non-transitory computer-readable storage medium wherein the item may be shipped four days prior to the event date.

The non-transitory computer-readable storage medium further includes expiring customer access to the instructional video after a predetermined amount of time has passed from the event date.

The non-transitory computer-readable storage medium wherein the predetermined amount of time for viewing the instructional video after the event date may be twenty-four hours.

In accordance with an additional embodiment, a method of providing one or more project kits to a customer prior to an event date utilizing a computer-implemented e-commerce system is disclosed. The method includes selecting, on a merchant website, at least one kit, including one or more items and an associated instructional video for purchase by the customer. The method includes allowing the customer to associate an event date with the kit. The method includes accepting payment from the customer for the kit. The method includes shipping one or more items associated with the kit to the customer prior to the event date, and providing electronic access to the instructional video in coordination with the shipment of the items to the customer.

The method further includes the step of expiring access to the instructional video after a predetermined amount of time has passed from the event date.

In accordance with an additional embodiment, a system of providing one or more project kits to a customer prior to an event date utilizing a computer-implemented e-commerce system is disclosed. The system includes means for selecting, on a merchant website, at least one kit, including one or more items and an associated instructional video for purchase by the customer. The system includes means for allowing the customer to associate an event date with the kit. The system includes means for accepting payment from the customer for the kit. The system includes means for shipping one or more items associated with the kit to the customer prior to the event date. The system includes means for providing electronic access to the instructional video in coordination with the shipment of the items to the customer.

The system further includes means for expiring access to the instructional video after a predetermined amount of time has passed from the event date.

### BRIEF DESCRIPTION OF THE SEVERAL VIEWS OF THE DRAWINGS

To these and to such other objects that may hereinafter appear, the present invention relates to an e-commerce system and method for bundling, selling and delivering do-it-yourself project kits to consumers as described in detail in the following specification and recited in the annexed claims, taken together with the accompanying drawings, in which like numerals refer to like parts in which:

FIG. 1 is a diagram illustrating a system for e-commerce in accordance with the preferred embodiment of the present invention;

FIG. 2 is a flow chart illustrating the steps of the method for purchasing bundled project kits online in accordance with the e-commerce system of FIG. 1;

FIG. 3 is a flow chart illustrating the steps of the method for delivering bundled project kits online in accordance with the e-commerce system of FIG. 1; and

FIGS. 4-1 and 4-2 are flow diagrams for conducting electronic transactions in the e-commerce system of FIG. 1.

To the accomplishment of the above and related objects the invention may be embodied in the form illustrated in the accompanying drawings. Attention is called to the fact, however, that the drawings are illustrative only.

Variations are contemplated as being part of the invention, limited only by the scope of the claims.

### DETAILED DESCRIPTION OF THE INVENTION

The preferred embodiment of the present invention relates to an event driven e-commerce system, method and computer readable medium for the sale and delivery of bundled do-it-yourself (DIY) project kits, which provide customers with the ability through a single purchase to make a finished product. In one embodiment, a customer may purchase a bundled project kit from a merchant website (for example, www.itsbyu.com) and specify an event date for completing the finished product. The bundled project kit includes one or more tangible items, possibly perishable, an associated digital instructional video. Once the merchant receives the payment (for example, through a payment gateway), the merchant may ship the tangible items directly to a recipient via a vendor. Once the items have shipped, the merchant may provide a secure connection to view the digital instructional video associated with the project kit purchased. The instructional video is available for viewing by the recipient for a predetermined amount of time before and after the event date.

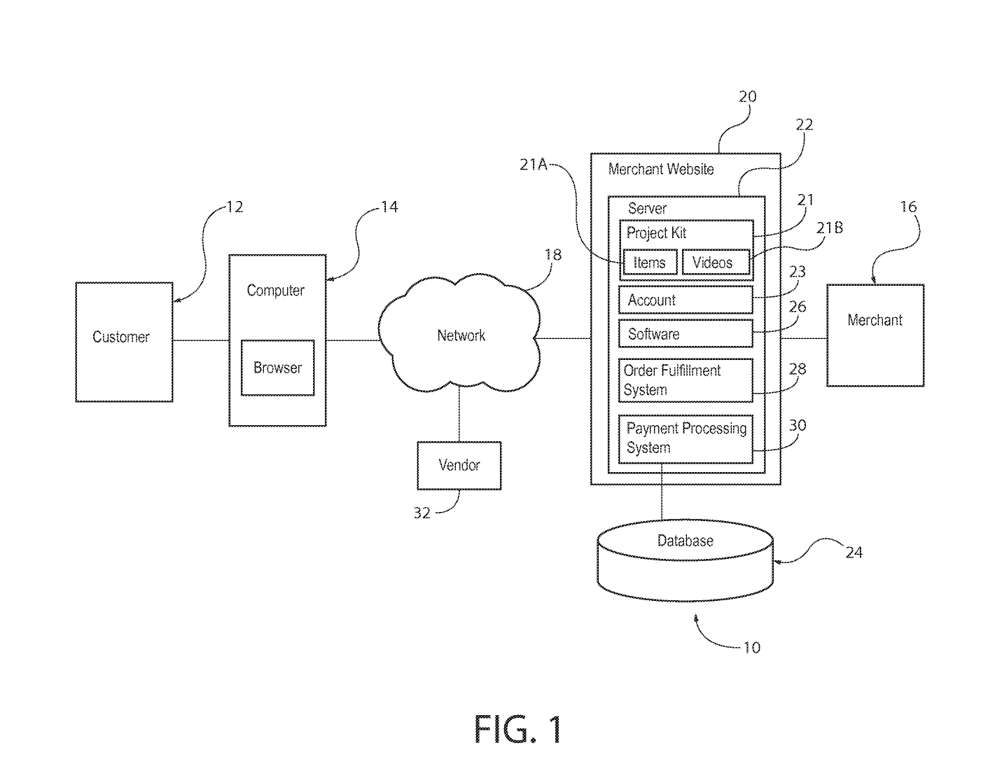

FIG. 1 illustrates the system 10 for e-commerce wherein a customer 12 may communicate via a device 14 (e.g. a computer, smart phone, tablet computer, or other consumer electronic device) with a merchant 16 via a network 18, such as the Internet. The customer 12 may also communicate via the network 18 with a merchant website 20 and various other vendors 32 (e.g. fulfilment or shipping vendors). In accordance with the preferred embodiment, the merchant website 20 offers for sale a variety of do-it-yourself project kits 21. The project kits 21 each include one or more tangible items or goods 21A bundled together with the associated instructional video 21B, which teaches the customer through step-by-step instructions how to assemble the finished product. The merchant website 20 is capable of selling the project kits 21 online and communicates with customers 12, for example, by operating a server 22 (e.g. computer processor). The server 22 presents the merchant website 20 for selling the kits and responds to client devices (e.g. device 14) by communicating over the network 18. The system includes a software application or a computer program 26 that is stored in a non-transitory computer readable storage medium such as a ROM (read-only memory), a flash memory, a floppy disc, a hard disc, an optical disc, a flash disc, a tape, a database accessible from the network 18 or any storage medium with the same functionality that can be contemplated by persons of ordinary skill in the art to which this invention pertains. The database 24 may also store customer specific information (e.g. email, event dates, orders, product kits) and product information (e.g. product kit SKU numbers). The instructional videos may also be stored in the database 24 and are accessible for viewing through an interface or customer account page 23 of the merchant website 20. The database 24 and may communicate with a remote web database for storing and streaming videos, like YouTube® owned by Google®. The merchant website 20 may also include an order fulfillment system 28 and payment processing system 30.

The computer application 26 may communicate (for example, using server 22) with various Application Programming Interfaces (APIs) that may enable various different types of relationships between the merchant website 20 and the customer 12.

In particular, in order for the customer to play video content on internet-connected devices (e.g. device 14), APIs native to such devices use a direct link to the video stream using providers like Youtube® or Vimeo. In the present invention, the computer application 26 may use an API that allows it to offer customers, through the interface 23 of the merchant website 20, the ability to view videos online. Access to the video may be provided by a secure connection (e.g. link) using a direct universal resource locator (URL). However, in doing so the customer would be able to download the video directly and then easily store, copy and further distribute the video. Therefore, it is preferable that the instructional videos are accessed via APIs that encapsulate these direct links to the videos and that can only work in the context of a web page in order to prevent viewers from directly accessing the data stream, and also to bar access to the video after a predetermined amount of time. As such, using YouTube® is the preferred method of providing the instructional videos to the customers.

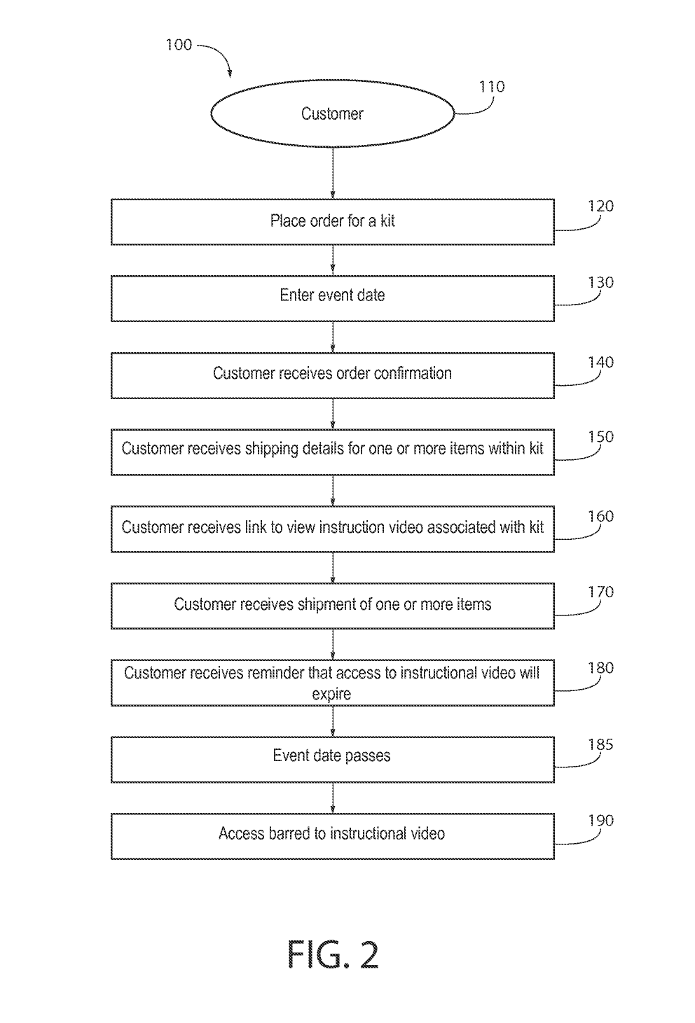

FIG. 2 illustrates a method 100, according to the preferred embodiment of the present invention, showing a process flow for the customer 12 placing an order via the Internet using the system 10 for e-commerce.

At step 110, the customer 12 uses their computer, or other mobile device, to connect to the Internet and shop online by visiting the merchant website 20 and browsing products offered for sale by the merchant 16. In particular, bundled DIY project kits 21. For purposes of illustration, a DIY floral arrangement for a wedding is contemplated. However, the project kit 21 may involve a variety of alternative projects, including but not limited to, flowers, faux flowers, perfume, cuisine, furniture, home décor, event décor, gardening, fashion, jewelry, accessories, toys, make-up, food, crafts, clothing and/or automotive.

At step 120, the customer places an order for a particular bundled project kit 21, specifically a floral bouquet, from the merchant website 18.

At step 130, the customer enters information related to the purchase including the event date (e.g. wedding date). Additional information may be required, including the name of a recipient, if different from the customer (for example, when purchased as a gift), the shipping address, and specific color of the kit (for example, when ordering a hand-tied wedding bouquet, the customer may select the type and/or color of the flowers).

At step 140, the customer receives an electronic communication, preferably via email, confirming the order was received by the merchant website 18.

At step 150, a predetermined amount of time before the event date, the customer receives an electronic communication, preferably via email that the tangible items 21A have shipped. In the preferred embodiment, the items 21A are perishable flowers and supplies for completing the floral arrangement and they will ship four days in advance of the wedding date. The email preferably contains delivery details, including the shipping vendor 31 (e.g. UPS, FEDEX, USPS) and tracking number so that the customer may monitor the status of delivery of the items 21A.

At step 160, also a predetermined amount of time before the event date, the customer receives an electronic communication, preferably via email, containing an indication that the instructional video 21B associated with the kit 21 is available for viewing. In particular, the indication in the email may include the embedded video message, or a URL link to the video message. Preferably, the customer receives the indication that the video is available for viewing, from the merchant 16, four days in advance of the event date. The instructional video may remain available for viewing by the customer for a predetermined amount of time after the event date, preferably twenty-four hours.

By clicking on the URL within the email, the customer is taken to the customer account page 23 of the merchant website 20 for viewing the instructional video. The customer account page 23 provides access to all customer orders past and present, as well as all associated instructional videos via the URL to the database 24 storing the instructional video. Once the customer clicks on the URL, they are brought to a new page on the merchant website 20 that allows the customer to view the full instructional video using YouTube®.

At step 170, the customer receives the shipment of the items 21A associated with the product kit 21 purchased.

At step 180, the customer receives an electronic reminder, preferably via email, that access to the instructional video will expire, preferably one date after the event date. At step 185, the event date specified by the customer occurs. At step 190, access to the instructional video 21B expires.

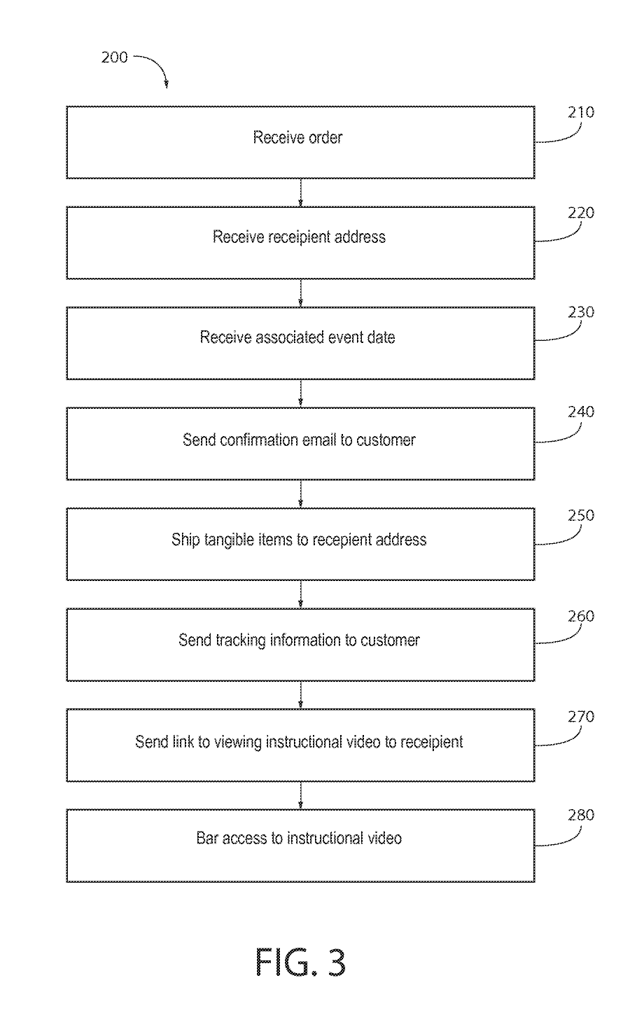

FIG. 3 illustrates a method 200, according to the preferred embodiment of the present invention, showing a process flow for the merchant 16 receiving an order placed via the Internet using the system 10 for e-commerce.

At step 210, the merchant 16 receives an order for a project kit 21.

At step 220, the merchant 16 receives the recipient's address. At step 230, the merchant 16 receives an event date associate with the project kit 21. At step 240, the merchant 16 sends the customer an electronic communication, preferably via email, confirming the order was received by the merchant website 18.

At step 250, a predetermined amount of time before the event date, the merchant 16 ships to the customer, via a fulfillment vendor 32, the tangible items 21A purchased.

At step 260, a predetermined amount of time before the event date, the merchant 16 sends the customer an electronic communication, preferably via email, that the tangible items 21A have shipped.

At step 270, also a predetermined amount of time before the event date, the customer receives an electronic communication, preferably via email, containing an indication that the instructional video 21B associated with the product kit 21 purchased is available for viewing.

At step 280, the merchant 16 uses the system 10 to bar access to the instructional video 21B by storing the event date in the database 24 as a time code associated with the order. The system 10 checks the current date on the server and if it matches predetermined time frame from the event date, the system will allow access to the videos in the customer account 23. When the current date and event date are outside the prescribed time allowance (e.g. 1 day, 2 days, 3 days etc.) access to the video is barred in customer account 23. The customer account 23 will reflect a default message.

The system 10 utilizes the event date provided by the customer and stores in the database 24 when the order is processed and shipped. All automatic electronic messages are generated and placed into a time queue on the server 22. The rules for sending these emails are configured using the administrative interface of the server 22.

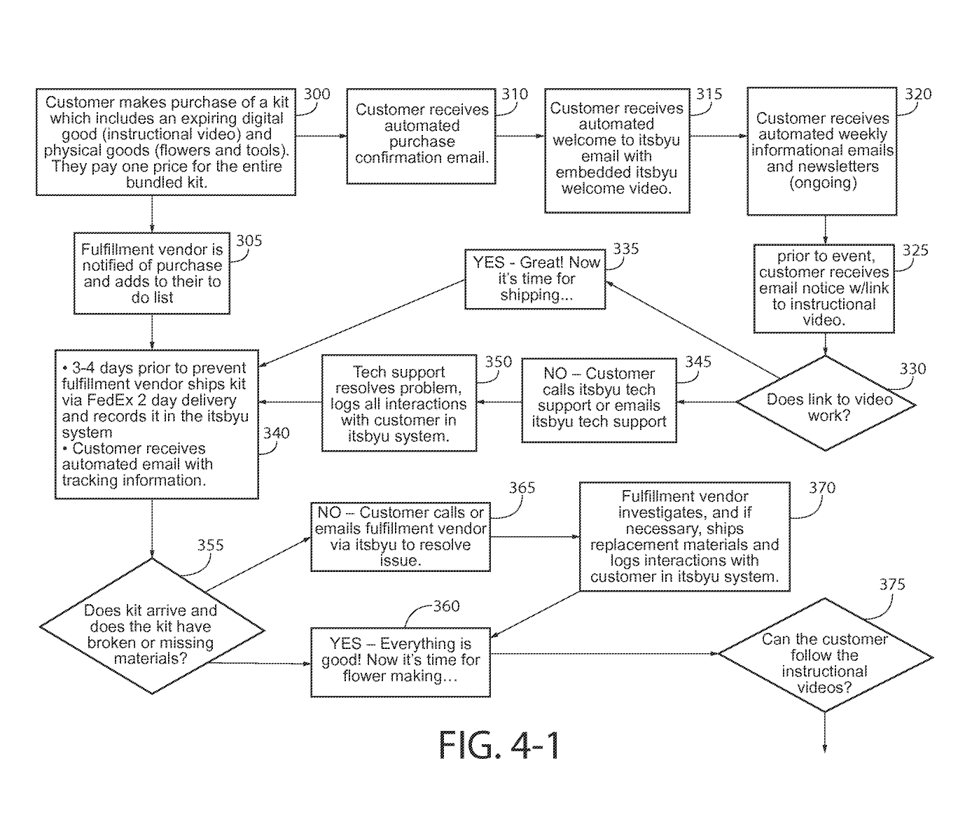

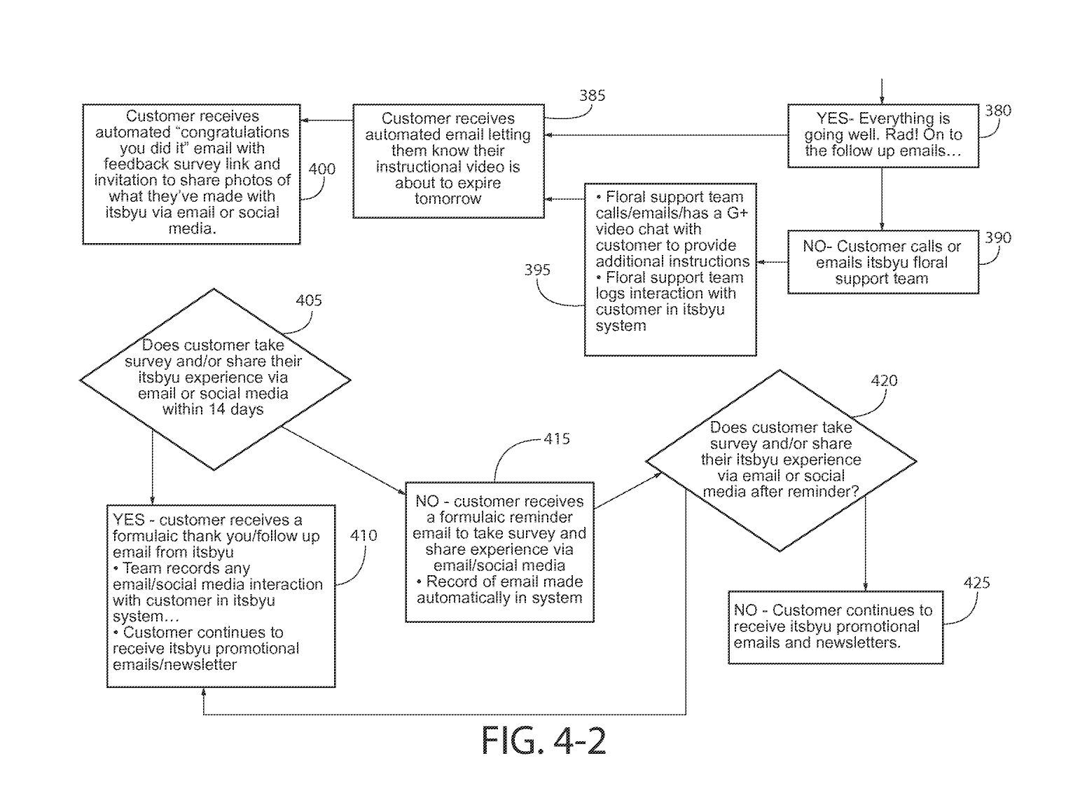

FIGS. 4-1 and 4-1 sequentially illustrate flow of information, tangible goods, digital videos and payments, that may occur between the customer 12, the merchant 16 and the vendors 32 in the system 10 for e-commerce. At step 300, the customer 12 orders the product kit 21. The customer must also provide payment to the merchant 16 for the product kit. At step 310, the customer 21 receives an automatic confirmation email from the merchant 16 that the ordered has been received and payment has successfully processed. At step 315, the customer receives a welcome email from the merchant 16, which may include an embedded welcome video. Once the merchant has welcomed the customer to the system 10, at step 320, the merchant may send the customer 12 periodic promotional and informational emails and newsletters. Prior to the event date, at step 325, the customer receives the email indicating access has been granted to the instructional video 21B. The customer 12 is able to access the instructional video and determine, at step 330, if the instructional video is viewable. If the video is viewable, at step 335, the process continues to order fulfillment. If the video is not viewable, at step 345, the customer may contact the merchant 16 via telephone or electronic communication. Once the merchant 16 resolves the problem and the customer is able to view the video, at step 350, the merchant 16 records all interaction details with the customer into the merchant website 20.

After the customer places the order for the product kit 21, at step 305, the system 10 automatically notifies the fulfillment vendor 32 of the purchase. At step 340, the fulfillment vendor 32 ships one or more items 21A associated with the kit 21 to the customer 12, and the customer simultaneously receives the email with shipping vendor details and tracking information. At step 355, the customer receives the items 21A and determines if any items or materials are missing, have perished, or have broken during transit. If items are missing or need replacing, then the customer 12 may place a request for replacement, at step 365, by contacting the merchant 16 via telephone or electronic communication. At step 370, the fulfillment vendor 32 investigates the request for replacement, and ships replacement items or materials to the customer 12. The fulfillment vendor 32 then records all interaction with the customer into the merchant website 20.

Once the items 21A are received by the customer, at step 355, the process continues to assemble the project kit 21 in accordance with the instructional video 21B. At step 375, the customer 12 begins assembling the project kit 21 in accordance with the instructional video 21B.

If the customer is unable to follow the directions in the instructional video, at step 390, the customer may contact the merchant 16 via telephone or electronic communication. At step 395, the merchant 16 provides additional instructions and support to the customer 12 via telephone, electronic communication, or G+ video chat. The merchant 16 then records all interaction with the customer into the merchant website 20.

If the customer 12 is able to follow the directions in the instructional video, or the customer is satisfied after receiving additional support from the merchant 16, the process continues to step 385, when the customer 12 receives from the merchant 16 the email reminder that the instructional video will expire.

At step 400, the customer 12 receives an email from the merchant 16 congratulating them on completing the project kit 21 and requesting the customer 12 complete an online survey about the system 10, and provides the customer with a link and invitation to share photos of the completed project via email or social media. At step 405, the system 10 determines whether the customer 12 has provided the requested feedback, and if not, at step 415, an automatic email reminder is sent to the customer 12. If the customer does not respond to the email reminder, or provide feedback, at step 420, periodic promotional and informational emails and newsletters are sent to the customer 12.

When the customer responds to the request for feedback, and provides feedback and or photographs of the completed project, at step 410, the system 10 generates an automatic thank you email to the customer, and then continues to periodically send the customer promotional and informational emails and newsletters.

It should be understood that numerous variations are possible, while adhering to the inventive concept. Such variations are contemplated as being a part of the present invention.

While only one preferred embodiment of the present invention has been disclosed for purposes of illustration, it is obvious that many modifications and variations could be made thereto. It is intended to cover all of those modifications and variations, which fall within the scope of the present invention as defined by the following claims.

We claim:

1. A method of providing one or more project kits to a customer prior to an event date utilizing a computer-implemented e-commerce system, the method comprising the steps of:
receiving an order for at least one product kit and specifying a recipient and an event date, wherein said order having been made by a customer, and wherein said kit includes at least one item and an instructional video associate with said item; and
fulfilling said order further comprising,
shipping said item to said recipient a predetermined amount of time before said event date, and
transmitting prior to said event date, by operation of one or more computer processors, at least an indication of the instructional video for viewing by the recipient for a predetermined amount of time after said event date.

2. The method of claim 1 further comprising the step of: providing an interface through which the recipient can view the instructional video on a computing device associated with the recipient.

3. The method of claim 1 further comprising the step of storing the plurality of instructional videos in a non-transitory computer readable storage medium.

4. The method of claim 3 further comprising the step of associating each video in the storage medium with one more project kits.

5. The method of claim 4 further comprising the step of processing online orders for the kit, by operation of one or more computer processors operably connected with the storage medium.

6. The method of claim 1 wherein the step of fulfilling the order further comprises the steps of:
providing, by operation of one or more computer processors, confirmation details that the item has shipped to the recipient; and
transmitting simultaneously with said confirmation details, the indication of the instructional video for viewing by the recipient.

7. The method of claim 1 wherein the instructional video is sent electronically to the recipient through the Internet.

8. The method of claim 1 wherein the indication of the instructional video is a URL transmitted to the recipient through an electronic message.

9. The method of claim 1 wherein the item is perishable goods.

10. The method of claim 1 wherein the item is shipped four days prior to the event date.

11. The method of claim 1 further comprising the step of expiring customer access to the instructional video after a predetermined amount of time has passed from the event date.

12. The method of claim 1 wherein the predetermined amount of time for viewing the instructional video after the event date is twenty-four hours.

13. A system of providing one or more project kits to a customer prior to an event date utilizing a computer-implemented e-commerce system, the system comprising:
means for storing a plurality of instructional videos associated with one or more items bundled together for sale as a kit;
means for processing online orders for said kits received from a customer, said means operably connected with said storing means; and
means for fulfilling said order comprising,
means for shipping said item to said recipient a predetermined amount of time before said event date, and
means for transmitting prior to said event date, by operation of said processor, at least an indication of the instructional video for viewing by the recipient for a predetermined amount of time after said event date.

14. The system of claim 13 further comprising means for providing an interface through which the recipient can view the instructional video on a computing device associated with the recipient.

15. The system of claim 13 wherein means for storing the plurality of instructional videos is a non-transitory computer readable storage medium.

16. The system of claim 14 further comprising means for associating each video with one more project kits.

17. The system of claim 15 further means for processing online orders for the kit, by operation of one or more computer processors operably connected with the storage medium.

18. The system of claim 13 wherein means for fulfilling the order further comprises:
means for providing confirmation details that the item has shipped to the recipient; and
means for transmitting simultaneously with said confirmation details, the indication of the instructional video for viewing by the recipient.

19. The system of claim 13 further comprising means for sending the instructional video to the recipient through the Internet.

20. The system of claim 13 wherein indication of the instructional video is a URL transmitted to the recipient through an electronic message.

21. The system of claim 13 wherein the item is perishable goods.

22. The system of claim 10 wherein the item is shipped four days prior to the event date.

23. The system of claim 13 further comprising means for expiring customer access to the instructional video after a predetermined amount of time has passed from the event date.

24. The system of claim 13 wherein the predetermined amount of time for viewing the instructional video after the event date is twenty-four hours.

25. A non-transitory computer-readable storage medium containing a computer program that, when executed, causes an event driven e-commerce system to perform the steps comprising:
receiving an order for at least one kit and specifying a recipient and an event date, wherein said order having been made by a customer, and wherein said kit includes an item and an instructional video associate with said item;
sending said item to said recipient a predetermined amount of time before said event date; and
transmitting prior to said event date at least an indication of the instructional video for viewing by the recipient for a predetermined amount of time after said event date.

26. The non-transitory computer-readable storage medium of claim 25 further comprising providing an interface through which the recipient can view the instructional video on a computing device associated with the recipient.

27. The non-transitory computer-readable storage medium of claim 25 further comprising storing the instructional video in a database; and associating the instructional video with at least one said kit.

28. The non-transitory computer-readable storage medium of claim 25 further comprising processing online orders for the kit, by operation of one or more computer processors operably connected with the storage medium.

29. The non-transitory computer-readable storage medium of claim 25 wherein to fulfill the order further comprises:
providing confirmation details that the item has shipped to the recipient; and
transmitting simultaneously with said confirmation details, the indication of the instructional video for viewing by the recipient.

30. The non-transitory computer-readable storage medium of claim 25 further comprises sending the instructional video to the recipient through the Internet.

31. The non-transitory computer-readable storage medium of claim 25 wherein indication of the instructional video is a URL transmitted to the recipient through an electronic message.

32. The non-transitory computer-readable storage medium of claim 25 wherein the item is perishable goods.

33. The non-transitory computer-readable storage medium of claim 25 wherein the item is shipped four days prior to the event date.

34. The non-transitory computer-readable storage medium of claim 25 further comprises expiring customer access to the instructional video after a predetermined amount of time has passed from the event date.

35. The non-transitory computer-readable storage medium of claim 25 wherein the predetermined amount of time for viewing the instructional video after the event date is twenty-four hours.

36. A method of providing one or more project kits to a customer prior to an event date utilizing a computer-implemented e-commerce system, the method comprising the steps of:
selecting, on a merchant website, at least one kit, including one or more items and an associated instructional video for purchase by the customer;
allowing the customer to associate an event date with said kit;
accepting payment from the customer for said kit;
shipping one or more items associated with said kit to said customer prior to said event date; and
providing electronic access to the instructional video in coordination with said shipment of said items to said customer.

37. The method of claim 36, further comprising the step of expiring access to the instructional video after a predetermined amount of time has passed from the event date.

38. A system of providing one or more project kits to a customer prior to an event date utilizing a computer-implemented e-commerce system, the system comprising:
means for selecting, on a merchant website, at least one kit, including one or more items and an associated instructional video for purchase by the customer;
means for allowing the customer to associate an event date with said kit;
means for accepting payment from the customer for said kit;
means for shipping one or more items associated with said kit to said customer prior to said event date; and
means for providing electronic access to the instructional video in coordination with said shipment of said items to said customer.

39. The system of claim 38, further comprising means for expiring access to the instructional video after a predetermined amount of time has passed from the event date.
